(19) United States
(12) Patent Application Publication
(10) Pub. No.: US 2010/0147645 A1
(43) Pub. Date: Jun. 17, 2010

(54) CLUTCH STRUCTURE

(76) Inventor: Katsuyuki Kodama, Taipei City (TW)

Correspondence Address: Muncy, Geissler, Olds & Lowe, PLLC, 4000 Legato Road, Suite 310, FAIRFAX, VA, 22033, US

(21) Appl. No.: 12/473,551

(22) Filed: May 28, 2009

(30) Foreign Application Priority Data
Dec. 12, 2008 (TW) 097222305

(51) Int. Cl. F16D 13/14

(52) U.S. Cl. 192/76

(57) ABSTRACT

The present invention provides an improved structure for a clutch, in which a clutch includes a flywheel, a connecting set and a plurality of clutch plates. The flywheel is divided into an upper layer and a lower layer, one side of the upper layer is provided with a tapped hole, and a screw is fitted in the tapped hole. The upper layer is provided with a plurality of supports that penetrate the upper and lower layer. Clutch plates and elastic elements respectively mount the supports, and the connecting set is structured from a sliding member and a fixed member. Accordingly, a tool can be used to adjust the aforementioned screw, thereby displacing the sliding member and causing the elastic elements to change the effectiveness of the elastic tension.

### BACKGROUND OF THE INVENTION

(a) Field of the Invention

The present invention relates to a clutch structure, and more particularly to an improved clutch structure that enables a screw tool to directly adjust the force of a spring without the need to disassemble the structure to enable easily adjusting the start up speed of a remote control automobile.

(b) Description of the Prior Art

Referring to FIG. 1, which shows a structural schematic view of a remote control automobile of the prior art, wherein a remote control automobile engine 10 is joined to a clutch 20, and a gear 252 located at the front end of the clutch 20 drives and rotates four tires 14 of the remote control automobile, thereby enabling the remote control automobile to move forward and backward.

Referring also to FIG. 2, which shows an exploded elevational view of the remote control automobile clutch of the prior art, and it can be clearly seen from the drawing that the remote control automobile engine 10 is fitted with a transmission shaft 11, and the exterior of the transmission shaft 11 is provided with a screw thread 12, which is used to fixedly connect the clutch 20 thereto, thereby enabling the motive power produced by the engine to be transmitted to the clutch 20. The clutch 20 comprises a flywheel 21, on which is located a plurality of protruding posts 211 used to assemble clutch plates 22. The prior art clutch 20 referenced in the present invention is assembled with three of the clutch plates 22, and three of the protruding posts 211 are correspondingly located on the flywheel 21. When the configured positions and angles of the protruding posts 211 are the same and shape, dimensions and size of the assembled clutch plates 22 are the same, then relatively more clutch plates 22 can be installed. However, regarding braking ability, two clutch plates 22 or three clutch plates 22 are preferred. The center of the flywheel 21 is provided with a hole 212, which is used for a tapered sleeve 213 to be mounted therein and thereby enable coupling to the transmission shaft 11 of the engine 10.

The number of assembled clutch plates 22 matches the number of the aforementioned protruding posts 211, and each of the clutch plates 22 comprises a fixed end 221 and a moving end 222. A recess 2211 defined in the fixed end 221 is used to receive and support a clutch spring 23, and two sides of the recess 2211 are provided with opposite facing holes 2222, which are used to mount onto the aforementioned respective protruding post 211 to form an actuating pivot for the clutch plate 22. A groove 223 is formed in the outer edge surface of the clutch plate 22 from the fixed end 221 to the moving end 222.

Torsion springs are adopted for the plurality of clutch springs 23, and a torsion main body 231 of each of the clutch springs 23 is disposed in the aforementioned respective recess 2211, and along with the holes 2222 in the fixed end 221 of the clutch plate 22, is mounted and fixed onto the respective protruding post 211. A spring arm 232 of each of the clutch springs 23 are then disposed in the aforementioned respective groove 223.

A central screw cap 24 is provided with a screw cap 241 and a screw rod 242, and the thread of the screw cap 241 matches the screw thread 12 of the transmission shaft 11 of the engine 10, thereby enabling fixing the flywheel 21 to the engine 10. The inside of the screw rod 242 is provided with an internal screw thread 2421.

A hole 251 defined central of a clutch cover 25 is used to enable the aforementioned screw rod 242 to penetrate and be disposed therein. A gear 252 is located on the outer edge of the cover body of the clutch cover 25 on the periphery of the hole 251, and is used to mesh with a gear 13 to drive and rotate the four wheels (see FIG. 1). Furthermore, in order to ensure smooth and steady running, the center of the gear 252 and the interior of the cover body of the clutch cover 25 are fitted with bearings 253, 254 respectively.

After mounting the aforementioned clutch cover 25 and the bearings 253, 254 to the aforementioned screw rod 242, then a screw 255 and a filling piece 256 are used to fixedly lock to an internal screw thread 2421 of the screw rod 242, whereupon the clutch cover 25 covers the exterior of the flywheel 21, thereby structuring the complete clutch 20. However, the following problems and shortcomings are still in need of improvement when using the aforementioned remote control automobile clutch of the prior art:

In the structure of the clutch 20, adjusting the time the clutch plates 22 are swung out is dependent on actual road conditions, and the size of the elastic force of the aforementioned clutch springs 23 is adjusted accordingly. The clutch springs 23 disclosed in FIG. 2 belong to torsion springs, and are not provided with the function to adjust the tension. Hence, the clutch springs 23 provided in the market are manufactured with different wire diameter specifications, thereby providing the clutch springs 23 with different tensions to enable controlling use in various configurations. The controller must purchase several of the clutch springs 23 having different wire diameters, and replace the clutch spring 23 whenever necessary according to actual road conditions, that is, disassemble the clutch 20 on the spot, replace with the possibly suitable clutch spring 23, and carry out a test run after reassembling, If the control result is unsatisfactory, then the clutch 20 must be disassembled again, the clutch spring 23 replaced with another, and another test run carried out after reassembling, this process being repeated until a satisfactory run has been achieved. Hence, time is lost in the continuous disassembling and replacement operations, and replacement is cumbersome and time-consuming, thus, there is a real need for further improvement.

### SUMMARY OF THE INVENTION

The primary objective of the present invention lies in: A clutch provided with a flywheel, the flywheel being divided into an upper layer and a lower layer. A hole is formed in the center of the lower layer. The upper layer is circumferentially disposed around the aforementioned hole on one surface of the lower layer. A connecting set is located in the center of the upper layer, and the connecting set is structured from a sliding member and a fixed member, the sliding member being mounted on the fixed member. Moreover, one side of the upper layer is provided with a tapped hole, and a screw is fitted in the tapped hole. The upper layer is provided with a plurality of supports that penetrate the upper layer and the lower layer. The clutch plates and elastic elements are respectively insertedly disposed on the supports, and ends of the elastic elements respectively abut against end areas of the clutch plates away from the supports, while the other ends of the elastic elements respectively abut against sides of the sliding member. Accordingly, when the user wants to alter the elastic strength of the elastic elements, a tool can be used to penetrate into the tapped hole and adjust the screw. When the screw is screwed inwardly, then the screw abuts against the sliding member, thereby causing the sliding member to rotatably slide, while at the same time, the elastic elements abutting against the sliding member change because of the abutment of the screw, causing the angle between the two ends of each of the elastic elements to expand, the elastic force also increases. On the contrary, when the screw is screwed outwardly, then the elastic force of the elastic elements decreases. According to the art described above, the present invention provides a breakthrough in solving the existing problems of a remote control automobile clutch of the prior art, in which the controller must purchase several clutch springs having different wire diameters, and replace the clutch spring whenever necessary according to actual road conditions, that is, disassemble the clutch on the spot, replace with a possibly suitable clutch spring, and carry out a test run after reassembling, If the control result is unsatisfactory, then the clutch must be disassembled again, the clutch spring replaced with another, and another test run carried out after reassembling, this process being repeated until a satisfactory run has been achieved, thus, time is lost in the continuous disassembling and replacement operations, and replacement is cumbersome and time-consuming; and achieves enabling the user to change the depth of the screw in the tapped hole using a tool. Moreover, the angle of the sliding member can be changed, which further changes the angle presented by the two ends of each of the elastic elements, thereby eliminating the need for the user to disassemble the entire structure, while realizing the practical advancement of easily adjusting the start up speed of a remote control automobile.

Furthermore, a cover member covers the exterior of the flywheel, one surface of the cover member is provided with a gear, and the center of the gear is provided with a connecting hole corresponding to the through hole. The gear is used to drive a transmission shaft of an engine.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a structural schematic view of a remote control automobile of the prior art.

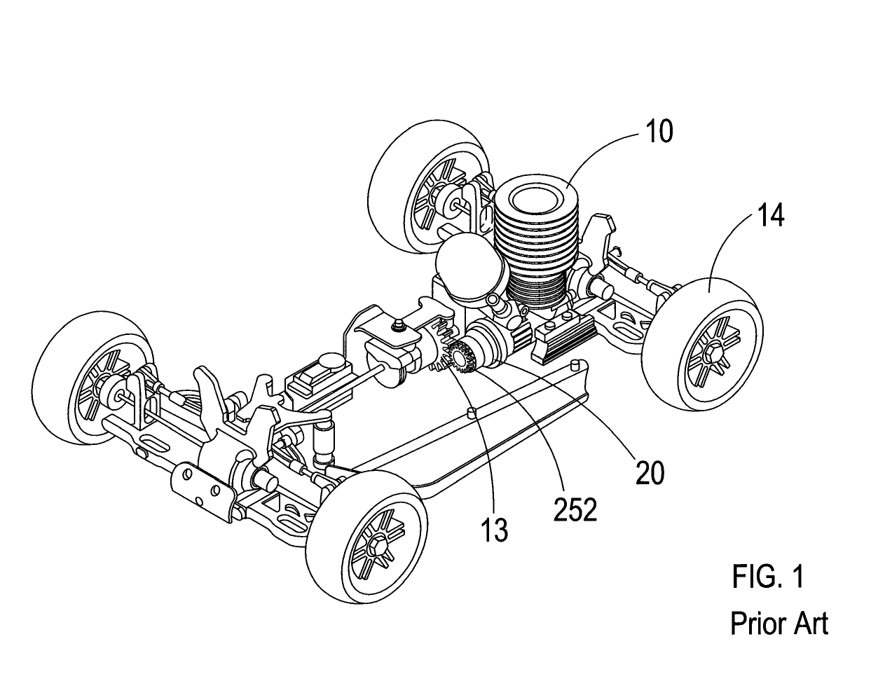

FIG. 2 is an exploded elevational view of a clutch of the prior art remote control automobile.

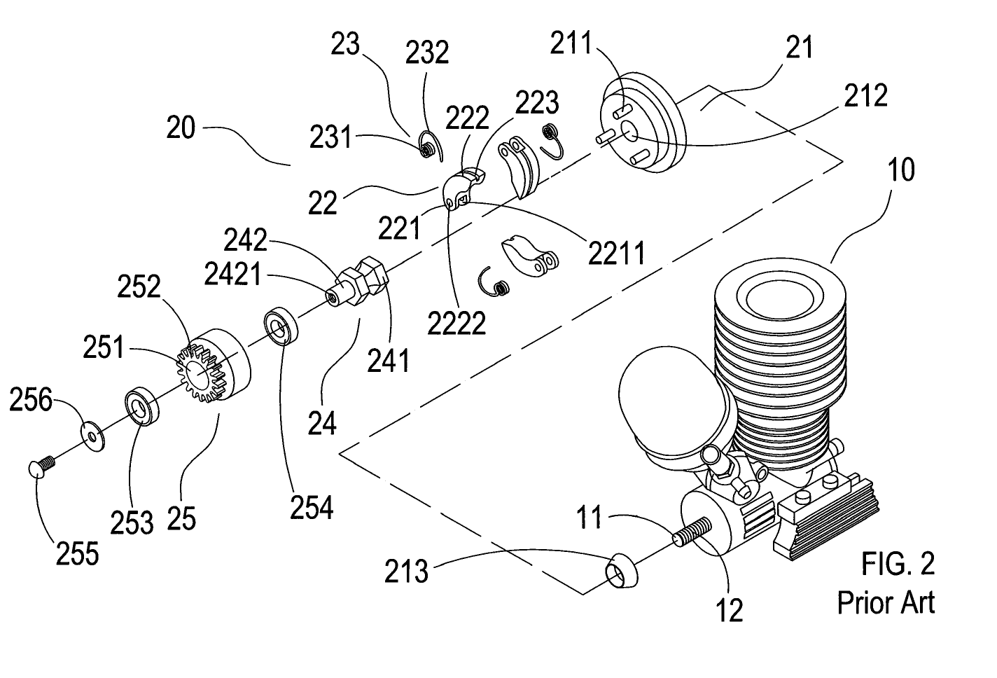

FIG. 3 is an elevational view of a preferred embodiment of the present invention.

FIG. 4 is an exploded elevational view of the preferred embodiment of the present invention.

FIG. 5 is an operational schematic view 1 of the preferred embodiment of the present invention.

FIG. 6 is an operational schematic view 2 of the preferred embodiment of the present invention.

### DETAILED DESCRIPTION OF THE PREFERRED EMBODIMENTS

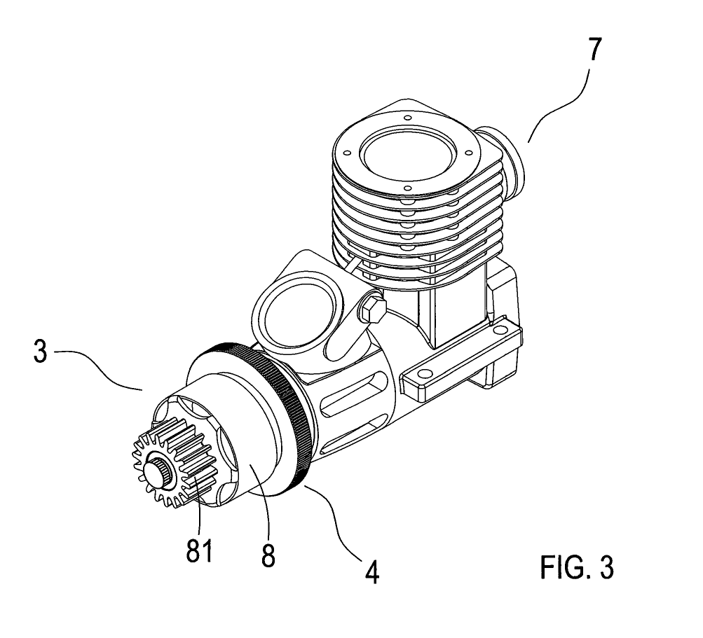

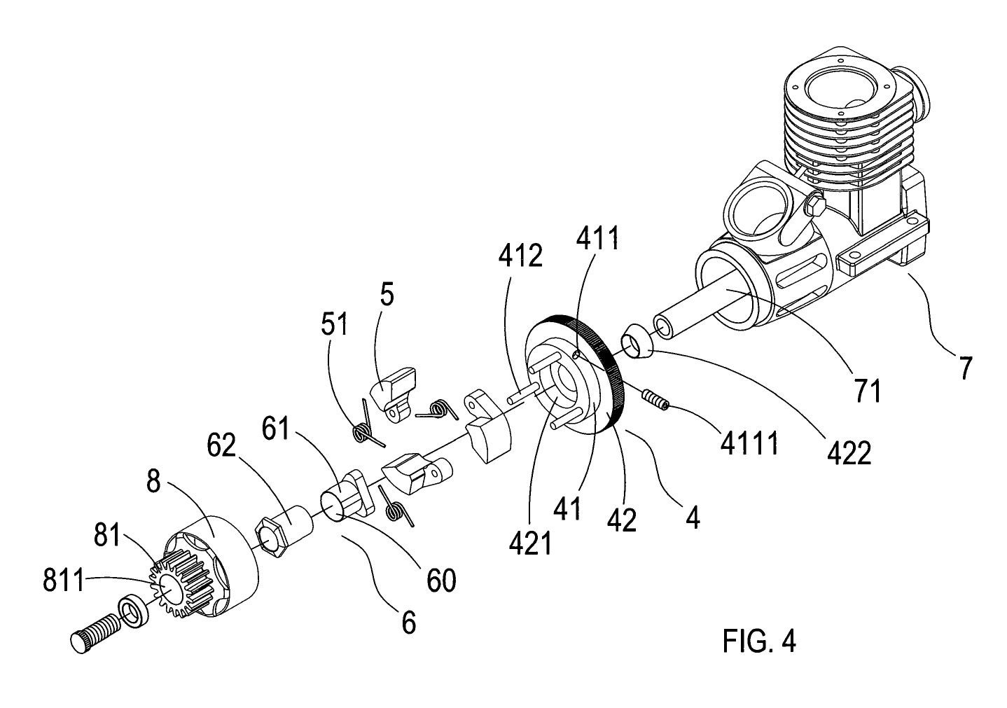

Referring to FIG. 3 and FIG. 4, which show an elevational view and an exploded elevational view respectively of a preferred embodiment of the present invention, and it can be clearly seen from the drawings that a clutch 3 comprises:

A flywheel 4, the flywheel is provided with an upper layer 41 and a lower layer 42, and a hole 421 is formed in the center of the lower layer 42. The upper layer 41 is circumferentially disposed around the hole 421, and one side of the upper layer 41 is provided with a tapped hole 411, which is fitted with a screw 4111. The upper layer 41 is provided with a plurality of supports 412 that penetrate the upper layer 41 and the lower layer 42. The supports 412 respectively insert into ends of respective clutch plates 5, and another end of each of the clutch plates 5 abuts against one end of another clutch plate 5. The clutch plates 5 are fitted with elastic elements 51 respectively mounted on the ends of the supports 412, and the elastic elements 51 are springs;

A connecting set 6, the connecting set 6 is located in the center of the upper layer 41, and the connecting set 6 is structured from a sliding member 61 and a fixed member 62. The sliding member 61 is mounted on the fixed member 62, and the fixed member 62 is fixedly locked to a transmission shaft 71 of an engine 7. The connecting set 6 is provided with a through hole 60, and the aperture of the through hole 60 is identical to the aperture of the aforementioned hole 421; and

A cover member 8, the cover member 8 covers the exterior of the flywheel 4, one surface of the cover member 8 is provided with a gear 81, and the center of the gear 81 is provided with a connecting hole 811 corresponding to the through hole 811.

Furthermore, the hole 421 of the flywheel 4 is disposedly mounted on the transmission shaft 71 of the engine 7 using a tapered sleeve 422 located therein.

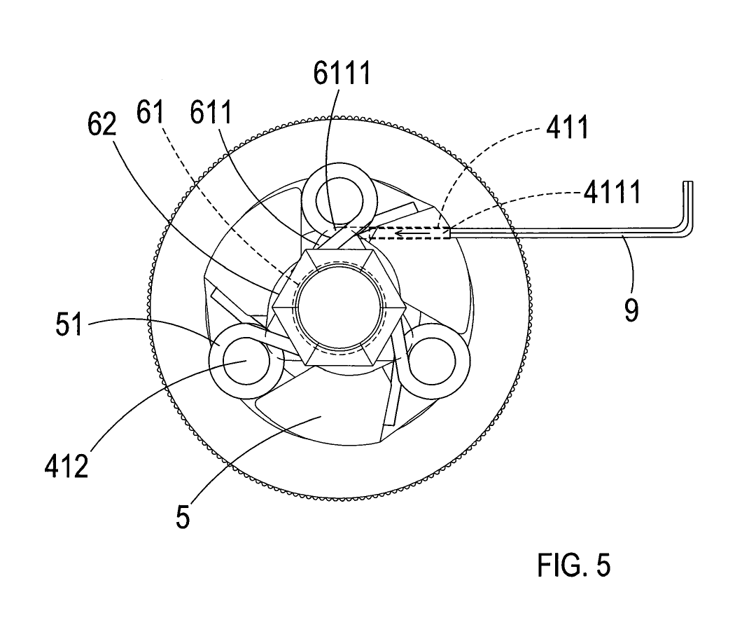

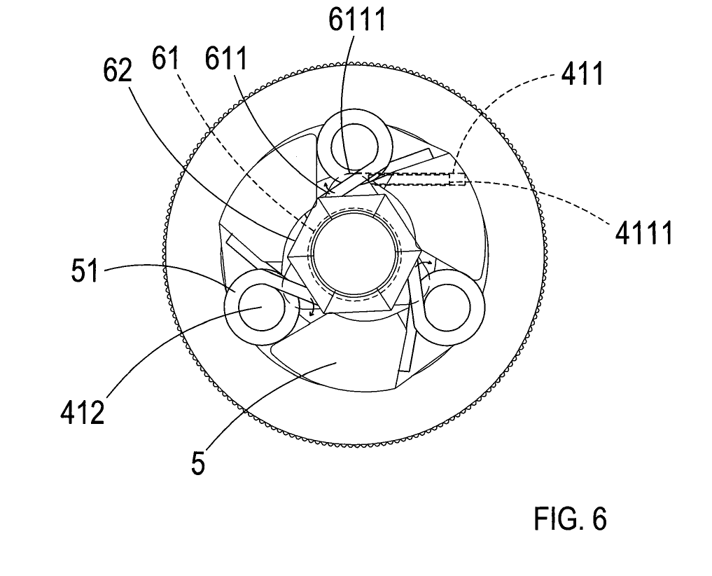

According to the aforementioned structure and constructional design, circumstances during operational use of the present invention are described hereinafter. Referring together to FIG. 4, FIG. 5 and FIG. 6, which show the exploded elevational view and operational schematic views 1, 2 of the preferred embodiment according to the present invention, and it can be clearly seen from the drawings that the flywheel 4 is separated into the upper layer 41 and the lower layer 42, wherein the hole 421 is formed at the center of the lower layer 42, and the upper layer 41 is circumferentially disposed around the aforementioned hole 421 on the lower layer 42. The connecting set 6 is located in the center of the upper layer 41, and the connecting set 6 is provided with the through hole 60, wherein the connecting set 6 is structured from the sliding member 61 mounted on the fixed member 62. One end of the sliding member 61 is provided with a sliding piece 611, one side of which is defined with a contact portion 6111. Furthermore, one side of the upper layer 41 is provided with the tapped hole 411, inside of which is fitted the screw 4111. The upper layer 41 is provided with the plurality of supports 412 which penetrate the upper layer 41 and the lower layer 42, and the supports 412 respectively insert into the clutch plates 5 and the elastic elements 51.

Ends of the elastic elements 51 respectively abut against end areas of the clutch plates 5 away from the supports 412, while the other ends of the elastic elements 51 respectively abut against sides of the sliding member 61. Hence, when the user wants to adjust the elastic strength of the elastic elements 51, the user can use a tool 9 to penetrate into the tapped hole 411 and adjust the depth of the screw 4111. When the start up speed of a remote control automobile needs to be boosted, then the screw 4111 can be screwed inwardly, and when the screw 4111 is inwardly screwed, the screw 4111 abuts against the contact portion 6111 of the sliding piece 611, thereby causing the sliding member 61 to move in one direction, and because ends of the elastic elements 51 abut against the sliding member 61, and the other ends abut against the other ends of the clutch plates 5, thus, when the sliding member 61 is rotatably displaced, then the two ends of each of the elastic elements 51 are braced open to form a larger angle, thereby strengthening the tension intensity of the elastic elements 51, as well as strengthening the tightness of the clutch plates 5. Hence, the initial reaction speed of the remote control automobile is increased.

Furthermore, when the engine 7 is running, because the fixed member 62 is connected to the transmission shaft 71 of the engine 7, thus, the fixed member 62 is caused to rotate along with the transmission shaft 71. Moreover, the natural rotating force causes the sliding member 61 and the fixed member 62 to rotate in the same direction.

In addition, when the flywheel 4 is rotating at high speed, then centrifugal force causes the clutch plates 5 to be thrown outward, simultaneously causing the cover member 8 covering the exterior of the flywheel 4 to rotate. Hence, the transmission shaft 71 of the engine 7 is caused to rotate.

Referring to all the drawings, the following advantages exist when using the present invention:

When wanting to boost the start up time of a remote control automobile, a tool need only be used to inwardly rotate the screw 4111 directly through the tapped hole 41 in one side of the flywheel 4, and at the same time the screw 4111 is inwardly rotated, then the screw 4111 abuts against the contact portion 6111 of the sliding piece 611, thereby forcing the sliding member 61 to rotate towards one direction. Moreover, because the two ends of each of the elastic elements 51 are respectively braced open from the clutch plates 5 by the sliding member 61, thus, when the sliding member 61 is again forced to rotate towards one direction, then the angle between the two ends of each of the elastic elements 51 expands, causing the tightness of the elastic elements 51 to tighten. At the same time, tightness of the clutch plates 5 increases along with expansion of the angle of each of the elastic elements 51. Accordingly, the start up speed of the remote control automobile can be boosted, and achieves the effectiveness of eliminating the need to disassemble the remote control automobile when adjusting the spring force.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A clutch structure, comprising:
a flywheel, the flywheel is provided with an upper layer and a lower layer, and a hole is formed in the center of the lower layer, the upper layer is circumferentially disposed around the hole, and one side of the upper layer is provided with a tapped hole, the upper layer is provided with a plurality of supports that penetrate the upper layer and the lower layer;
a connecting set, the connecting set is located in the center of the upper layer, and the connecting set is provided with a through hole;
a plurality of clutch plates, ends of the clutch plates respectively mount onto the supports, and another end of each of the clutch plates abuts against one end of another clutch plate; and
a cover member, the cover member covers the exterior of the flywheel, and one surface of the cover member is provided with a gear, the center of the gear is provided with a connecting hole corresponding to the through hole.

2. The clutch structure according to claim 1, wherein the connecting set is structured from a sliding member and a fixed member, the sliding member is mounted on the fixed member.

3. The clutch structure according to claim 1, wherein the connecting set is fixedly locked to a transmission shaft of an engine by means of the fixed member.

4. The clutch structure according to claim 1, wherein the aperture of the hole is the same as the aperture of the through hole.

5. The clutch structure according to claim 1, wherein the clutch plates are fitted with elastic elements and mutually mounted on the ends of the supports.

6. The clutch structure according to claim 5, wherein the elastic elements are springs.

7. The clutch structure according to claim 1, wherein the tapped hole is fitted with a screw.
